(19) United States
(12) Patent Application Publication
(10) Pub. No.: US 2008/0051188 A1
(43) Pub. Date: Feb. 28, 2008

(54) Gaming machine and method for providing game

(75) Inventor: Yukinori Inamura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/892,166

(22) Filed: Aug. 20, 2007

(30) Foreign Application Priority Data
Aug. 21, 2006 (JP) 2006-224300

(51) Int. Cl. A63F 13/00; G06F 17/00

(52) U.S. Cl. 463/20

(57) ABSTRACT

A gaming machine provides a game and includes: a display device; an operation unit that allows a player to input commands for playing the game; and a controller. The controller operates to: control the display device to variably display a plurality of symbols in each of a plurality of symbol display areas when a start command is input through the operation unit; define a part of the symbol display areas as activated symbol display areas; provide an award when a combination of the symbols displayed stopped in the activated symbol display areas satisfies a predetermined combination; and modify the symbol display areas to be defined as the activated symbol display areas when a predetermined condition is satisfied.

### CROSS-REFERENCE TO THE RELATED APPLICATION(S)

The present application is based upon and claims priority from prior Japanese Patent Application No. 2006-224300, filed on Aug. 21, 2006, the entire content of which are incorporated herein by reference.

### TECHNICAL FIELD

The present invention relates to a gaming machine and a method for providing a game in which an award is provided to a player based on a combination of symbols displayed on a display device. The present invention also relates to a gaming machine and a method for providing a game in which an activated symbol display area, where symbols to be considered when determining the combination are displayed, is changed when a predetermined condition is satisfied.

### BACKGROUND

Conventionally, a slot machine, as one type of gaming machines, is configured to start a game when a game medium such as a coin is inserted into the gaming machine by a player. When the game is started, symbol columns are displayed stopped in each of a plurality of display areas after being variably displayed for a predetermined time period. The slot machine provides an award to the player based on a combination of the symbols being displayed stopped.

The gaming machine is generally configured to determine whether or not an award providing combination of the symbols is satisfied to provide the award, by determining whether a predetermined number of symbols of the same kind (for example, “CHERRY” or “7”) are arranged on a predetermined pay line. Alternatively, the conventional gaming machine is configured that the award is provided based on the award providing combination without defining the pay line.

For example, documents U.S. Pat. No. 6,093,102 and U.S. Pat. No. 6,960,133 disclose a slot machine that displays a total of 15 symbols arranged in 3×5 matrix by video reels or mechanical reels. In the slot machine, vertically arranged columns of symbols start to variably displayed by rotating the reels when a game is started, and after a predetermined time lapses, three symbols are displayed stopped in each of the columns by stopping the rotation of the reels. An award is provided when the symbols are stop displayed in a combination including a predetermined number or more of symbols of the same kind.

In the conventional slot machine, the symbol display areas that display symbols establishing the combination are fixedly arranged in predetermined positions and in a predetermined number of pieces. That is, the number and positions of the symbol display areas displaying the symbols is fixedly defined in the slot machine and never been changed. For example, the slot machine disclosed in the document U.S. Pat. No. 6,093,102 is configured to display a total of 15 symbols in 15 fixed symbol display areas arranged in 3×5 matrix, with five video reels.

### SUMMARY

One of objects of the present invention is to provide a gaming machine and a method for providing a player an attractive game in which activated symbol display areas, in which symbols that establish a combination for determining an award to be provided are displayed, when a predetermined condition is satisfied, to thereby improve an excitement of the player.

According to a first aspect of the invention, there is provided a gaming machine that provides a game and includes: a display device; an operation unit that allows a player to input commands for playing the game; and a controller that operates to: control the display device to variably display a plurality of symbols in each of a plurality of symbol display areas when a start command is input through the operation unit; define a part of the symbol display areas as activated symbol display areas; provide an award when a combination of the symbols displayed stopped in the activated symbol display areas satisfies a predetermined combination; and modify the symbol display areas to be defined as the activated symbol display areas when a predetermined condition is satisfied.

According to a second aspect of the invention, there is provided a gaming machine that provides a game and includes: a display device; an operation unit that allows a player to input commands for playing the game; and a controller that operates to: accept a bet input by the player through the operation unit; control the display device to variably display a plurality of symbols in each of a plurality of symbol display areas when a start command is input through the operation unit; provide an award when a combination of the symbols displayed stopped in the symbol display areas satisfies a predetermined combination; and control the display device to increase a number of symbol display areas to be displayed as a number of bet made by the player through the operation unit increases.

According to a third aspect of the invention, there is provided a method for providing a game to a player, the method including: allowing a player to input commands for playing the game; variably displaying a plurality of symbols in each of a plurality of symbol display areas when a start command is input by the player; defining a part of the symbol display areas as activated symbol display areas; providing an award when a combination of the symbols displayed stopped in the activated symbol display areas satisfies a predetermined combination; and modifying the symbol display areas to be defined as the activated symbol display areas when a predetermined condition is satisfied.

According to a fourth aspect of the invention, there is provided a method for providing a game to a player, the method including: allowing a player to input commands for playing the game; and accepting a bet input by the player; variably displaying a plurality of symbols in each of a plurality of symbol display areas when a start command is input by the player; providing an award when a combination of the symbols displayed stopped in the symbol display areas satisfies a predetermined combination; and increasing a number of symbol display areas to be displayed as a number of bet made by the player increases.

### BRIEF DESCRIPTION OF THE DRAWINGS

In the accompanying drawings:

FIG. 1 is a view showing a symbol display screen in a case in which, in a slot machine according to a first embodiment, a game is started with 1 BET, and symbols are stop displayed in symbol display areas;

FIG. 2 is a view showing the symbol display screen in a case in which, in the slot machine according to the first embodiment, the game is started with 5 BETs, and symbols are stop displayed in symbol display areas;

FIG. 3 is a perspective view showing an appearance of the slot machine according to the first embodiment;

FIG. 4 is a front view showing a die rolling on the symbol display screen according to the first embodiment;

FIG. 5 is a front view showing symbols displayed on the symbol display screen according to the first embodiment as the rolling of the die stops;

FIG. 6 is a diagram showing details of symbols and prizes displayed on the symbol display screen of the slot machine according to the first embodiment;

FIG. 7 is a block diagram schematically showing a control system of the slot machine according to the first embodiment;

FIG. 8 is a flowchart of a main control process program in the slot machine according to the first embodiment;

FIG. 9 is a flowchart of a main game process program in the slot machine according to the first embodiment;

FIG. 10 is a flowchart of a main control process program in a slot machine according to a second embodiment;

FIG. 11 is a front view showing a symbol display screen of a slot machine according to a third embodiment;

FIG. 12 is a view showing the symbol display screen in a case in which, in the slot machine according to the third embodiment, a game is started with 1 BET, and symbols are stop displayed in symbol display areas;

FIG. 13 is a view showing the symbol display screen in a case in which, in the slot machine according to the third embodiment, the game is started with 2 BETs, and symbols are stop displayed in symbol display areas;

FIG. 14 is a diagram showing details of symbols and prizes displayed on the symbol display screen of the slot machine according to the third embodiment;

FIG. 15 is a view showing a symbol display screen in a case in which, in a slot machine according to a fourth embodiment, a game is started with 1 BET, and symbols are stop displayed in symbol display areas;

FIG. 16 is a view showing the symbol display screen in a case in which, in the slot machine according to the fourth embodiment, the game is started with 2 BETs, and symbols are stop displayed in symbol display areas; and

FIG. 17 is a view showing the symbol display screen in a case in which, in the slot machine according to the fourth embodiment, the game is started with 3 BETs, and symbols are stop displayed in symbol display areas.

### DETAILED DESCRIPTION

Hereafter, a detailed description will be given, while referring to the drawings, of a gaming machine according to the invention, based on a first to a fourth embodiment in which embodied as a slot machine. Herein, the slot machine according to the embodiments is a so-called video slot machine which, having an image display device such as a liquid crystal display panel, and performs a game by displaying an image of symbols of a plurality of kinds on a screen of the image display device.

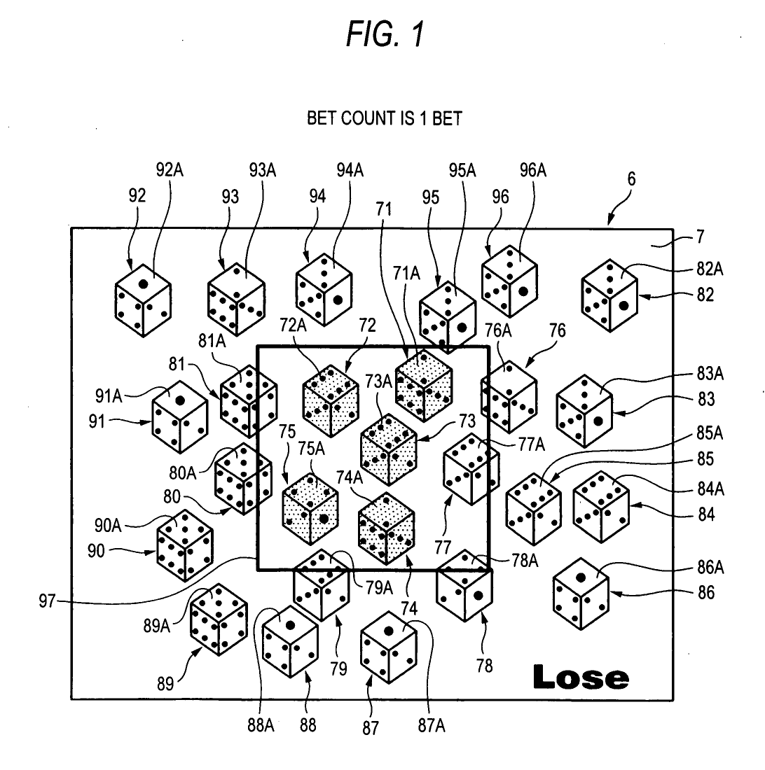

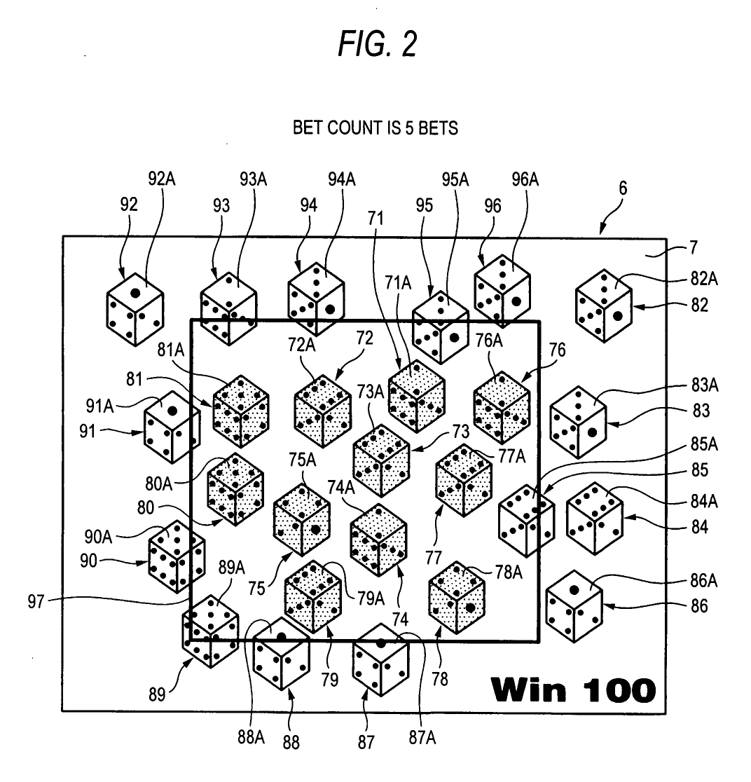

The slot machine according to the embodiments provides an award in the event that a predetermined number or more of symbols of the same kind are arranged on a display as one aspect of an award providing combination, as shown in FIGS. 1 and 2. The slot machine, as a number of bets (referred to as “bet count”) made by the player at a start reception time increases, enlarges a symbol display area (referred to hereafter as “activated symbol display area”) in which symbols that establish an award providing combination (the symbols will be simply referred to as “activated symbols”).

For example, when the bet count is 1 BET, as shown in FIG. 1, five pieces of dice 71-75, each of which serving as the symbol display area, displayed within an area defined by a separation line 97, are considered to be the activated symbol display areas. In this case, an award is provided based on a combination of the symbols 71A-75A of dice spots (one of “1” to “6”) displayed on a top face of each dice 71-75.

Meanwhile, when the bet count is 5 BETs, as shown in FIG. 2, 11 pieces of dice 71-81, each of which serving as the symbol display area, displayed within an area defined by the separation line 97 being enlarged with respect to the state shown in FIG. 1, are considered to be the activated symbol display areas. In this case, an award is provided based on a combination of the symbols 71A-81A of dice spots displayed on the top face of each dice 71-81.

As described, by a number of bets (bet count) received in the slot machine increases, the activated symbol display areas displaying the activated symbols that establishes the combination increase, improving a possibility of satisfying the award providing combination.

### FIRST EMBODIMENT

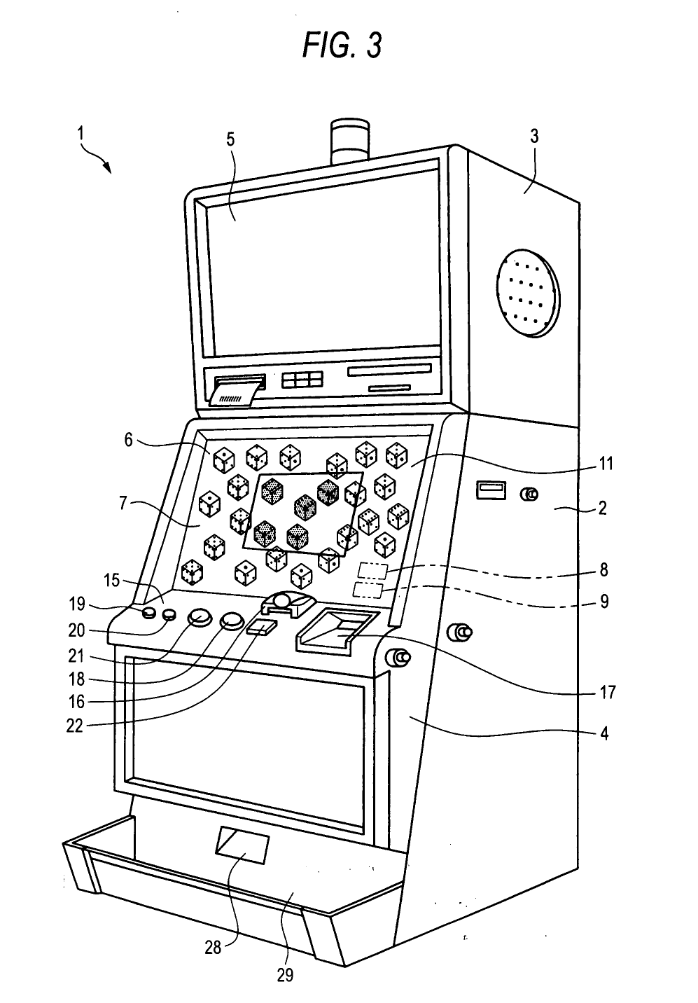

A configuration of a slot machine 1 according to a first embodiment will be described with reference to FIG. 3. FIG. 3 is a view showing an appearance of the slot machine 1 according to the first embodiment.

The slot machine 1 according to the first embodiment includes a cabinet 2, a top box 3 that is mounted on top of the cabinet 2, and a main door 4 provided on a front of the cabinet 2.

An upper display 5 is provided on a front of the top box 3. The upper display 5 is provided with a liquid crystal display device and displays information related to the game including a method to play the game, a payout table, and the like.

A lower display 6 is provided on a front of the main door 4. The lower display 6 is provided with a liquid crystal display device and displays a symbol display screen 7 including images of dice 71-96 that serve as 26 pieces of symbol display areas. The symbol display screen 7 includes images of a separation line 97 that separates activated symbol display areas (in FIG. 1, the dice 71-75) from other symbol display areas (in FIG. 1, the dice 76-96). When the game is started, the dice 71-96 start rolling, and dice spot symbols (one of “1” to “6”) are variably displayed on each of the dice 71-96. After a predetermined time lapses, symbols 71A-96A are stop displayed one on a top face of each of the dice 71-96 respectively. Only dice entirely enclosed by the separation line 97 are taken as the activated symbol display areas, and a predetermined award is provided to the player based on a combination of activated symbols displayed in the activated symbol display areas.

It is also acceptable, in place of the dice, to employ reels which scroll display symbols, and a number of dice or reels displayed is not limited to 26 pieces. A number of dice to be set as the activated symbol display areas may not be limited to a specific plural number, but may also be only one.

A touch sensitive screen 11 is provided on a front of the lower display 6. The touch sensitive screen 11 allows the player to input various instructions by touch operations.

A credit count display portion 8 and a payout count display portion 9 are provided on the lower display 6. A credit count, which is a number of credits the player currently owns, is displayed in the credit count display portion 8. A value of an award to be awarded in the event that the combination of symbols stop displayed on the symbol display screen 7 is a predetermined award providing combination is displayed as a payout count in the payout count display portion 9.

A control panel 15 on which are positioned a plurality of buttons with which instructions from the player relating to a game implementation are input, a coin insertion slot 16, which accepts a coin as a game medium, and a bill insertion slot 17 are provided below the lower display 6.

A START button 18, a CHANGE button 19, a CASH OUT button 20, a 1-BET button 21 and a MAX-BET button 22 are provided on the control panel 15. The START button 18 serves as an operation unit for inputting an instruction to start a variable display of symbols on the dice 71-96. The CHANGE button 19 serves as an operation unit used to request a changing of money from an attendant of a game arcade. The CASH OUT button 20 serves as an operation unit for inputting an instruction to pay coins from a coin payout opening 28 into a coin tray 29, in accordance with the credit count which the player owns (one credit corresponds to one coin), or an instruction to pay out by means of a bar-coded ticket.

The 1-BET button 21 serves as an operation unit for receiving an instruction to bet one credit, from among the credits which the player owns, on the game. The MAX-BET button 22 serves as an operation unit for receiving an instruction to bet a maximum credit count (in the first embodiment, 5 credits), from among the credits which the player owns, which can be bet on one game. As the BET buttons, it is also possible to provide other various kinds of BET button such as a 3-BET button.

In the slot machine 1 according to the first embodiment, a coin, a bill, or electronic valuable information (a credit) equivalent to them, is used as the game medium. However, the game medium applicable to the invention, not being limited to these, can include, for example, a medal, a token, electronic money or a ticket.

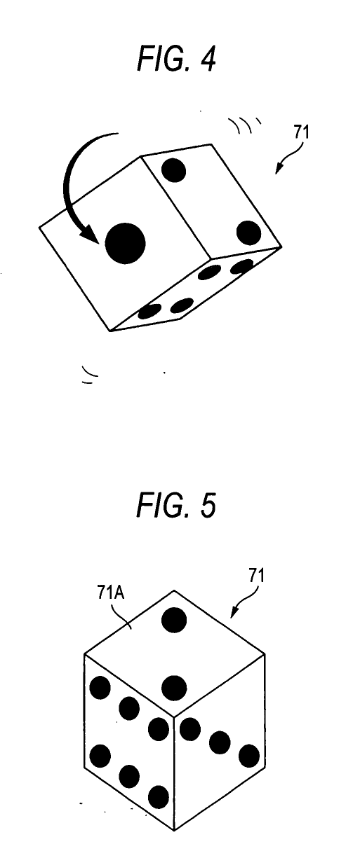

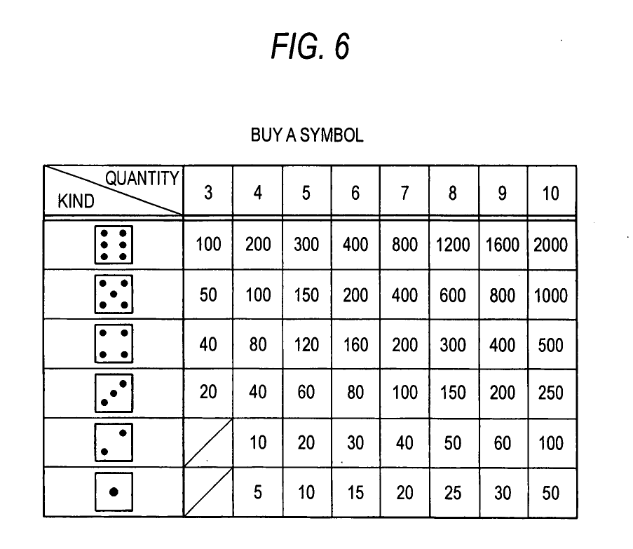

A description will be given, based on FIGS. 1, 2 and 4-6, of dice and symbols which are displayed on the symbol display screen 7 of the lower display 6 during the game. FIG. 4 is a front view showing the die 71 which rolls in the symbol display screen 7 according to the first embodiment, FIG. 5 is a front view showing symbols which, the rolling of the die 71 stopping, are displayed on the symbol display screen 7 according to the first embodiment, and FIG. 6 is a diagram showing details of symbols and prizes which are displayed on the symbol display screen 7. Hereafter, using FIGS. 4 and 5, a description will be given, particularly of the die 71, from among the 26 dice 71-96 used in the game, as an example. Then, the other dice 72-96 having the same configuration as the die 71, a description thereof will be omitted.

As shown in FIGS. 4 and 5, the die 71 displayed on the symbol display screen 7 according to the first embodiment is a regular hexahedron on faces of which are arranged six kinds of symbol “1”, “2”, “3”, “4”, “5” and “6” respectively. When the game is started, the die 71 starts rolling, and the symbols arranged on the faces also rotate accordingly. Subsequently, when the rolling of the die 71 stops, the rotation of the symbols also stops accordingly, and one symbol 71A (in FIG. 5, “2”) is displayed on the top of the stopped die 71. Then, the symbol 71A displayed on this top becomes a symbol displayed on the die 71, which is a symbol display area.

In FIG. 5, although, apart from the symbol 71A, adjacent symbols (in FIG. 5, “3” and “6”) are also displayed, it is also acceptable to display the symbol 71A alone. Also, it is also acceptable that the die 71 repeatedly performs the rolling and stopping in a fixed position of the symbol display screen 7, or rolls while moving on the symbol display screen 7. Furthermore, it is also acceptable to cause the rolling die 71 to enter the screen from outside.

In the slot machine 1 according to the first embodiment, the game is performed using the 26 dice described in FIGS. 4 and 5. Then, only symbols, from among the symbols 71A-96A displayed on the tops of the 26 dice 71-96, on dice entirely contained and arranged inside the separation line 97, a range of which is set based on the number of bets made by the player at the start reception time, can be elements of a combination which establishes an award. As dice (in FIG. 1, the dice 71-75) displaying activated symbols which can be elements of the combination are displayed in a color differing from a color of the other dice (in FIG. 1, the dice 76-96) (for example, yellow and white), it is possible for the player to easily ascertain the dice displaying the activated symbols which can be elements of the combination. As a method of distinguishing the dice, apart from differentiating the display colors, it is sufficient to display the dice which are the activated symbol display areas and the other dice in differing display states. It is possible to differentiate the display states, for example, by making a size of dice displaying the activated symbols larger than that of the other dice, lighting only the dice displaying the activated symbols using a backlight, and so on.

A win occurs in the event that the combination of the activated symbols is a combination in which the predetermined number or more of symbols of the same kind are displayed, and an award corresponding to a kind and a display quantity of the symbols is provided. Also, in the event that a bonus combination occurs in which all the activated symbols displayed inside the separation line 97 are configured of the “1” symbols, as the award, a bonus game is executed continuously after a finish of a base game.

In the slot machine 1 according to the first embodiment, as shown in FIGS. 1 and 2, along with the increase in the number of bets made by the player at the start reception time, a number of activated symbols for which an award is provided increases. For example, when the bet count is 1 BET, as shown in FIG. 1, five pieces of dice 71-75 positioned only in the vicinity of the center enclosed by the separation line 97 are considered to be the activated symbol display areas. Then, the award is provided based on a combination of the dice spot symbols 71A-75A displayed one (one of “1” to “6”) on the top of each die 71-75. Herein, the award providing combination, as shown in FIG. 6, is a combination in which is displayed the predetermined number or more of symbols of the same kind. Specifically, in FIG. 1, although two “2” symbols, one “4” symbol and two “6” symbols are displayed as the symbols 71A-75A, this combination does not establish the award providing combination.

Meanwhile, when the bet count is 5, as shown in FIG. 2, 11 pieces of dice 71-81 enclosed by the separation line 97, which is more enlarged than in FIG. 1, are considered to be the activated symbol display areas. An award is provided based on a combination of the dice spot symbols 71A-81A displayed one on the top of each die 71-81. Specifically, in FIG. 2, three “2” symbols, two “4” symbols, two “5” symbols and four “6” symbols are displayed as the symbols 71A-81A and, as a result, a combination is established for which is provided an award of 100 credits based on the fact that the four “6” symbols are displayed at the same time. Consequently, even in the event that an identical symbol is displayed on each of the dice 71-96, the details of the award change depending on the number of bets received in the slot machine 1.

Although no illustration is given for when the bet count is 2, 3 or 4, when the bet count is 2, the separation line 97 is more enlarged than when it is 1, and the activated symbol display areas also increase. In the same way, when the bet count is 3, the separation line 97 is more enlarged than when it is 2, and a number of the activated symbol display areas also increases. Also, when the bet count is 4, the separation line 97 is more enlarged than when it is 3, and the number of activated symbol display areas also increases. When the bet count is 5, which is a maximum bet count, the separation line 97 becomes most enlarged, and the number of activated symbol display areas becomes maximum size.

A specific description will be given of a game implementation procedure of the slot machine 1 according to the first embodiment. First, when the START button 18 is pressed after a finish of the bet reception, dice (that is, activated symbol display areas) displaying symbols which establish the award providing combination are determined based on the number of bets made by the player. Subsequently, an internal selection process which determines symbols 71A-96A to be displayed on the tops of the dice 71-96 is performed. At a point at which a predetermined time has elapsed after the START button 18 is pressed, the dice 71-96 start rolling, a variable display of symbols is performed and, after the predetermined time lapses, a total of 26 symbols 71A-96A are stop displayed. Then, details of an award are determined based on a combination of symbols displayed on dice (activated symbol display areas) enclosed by the separation line 97 set based on the bet count, and the award is provided.

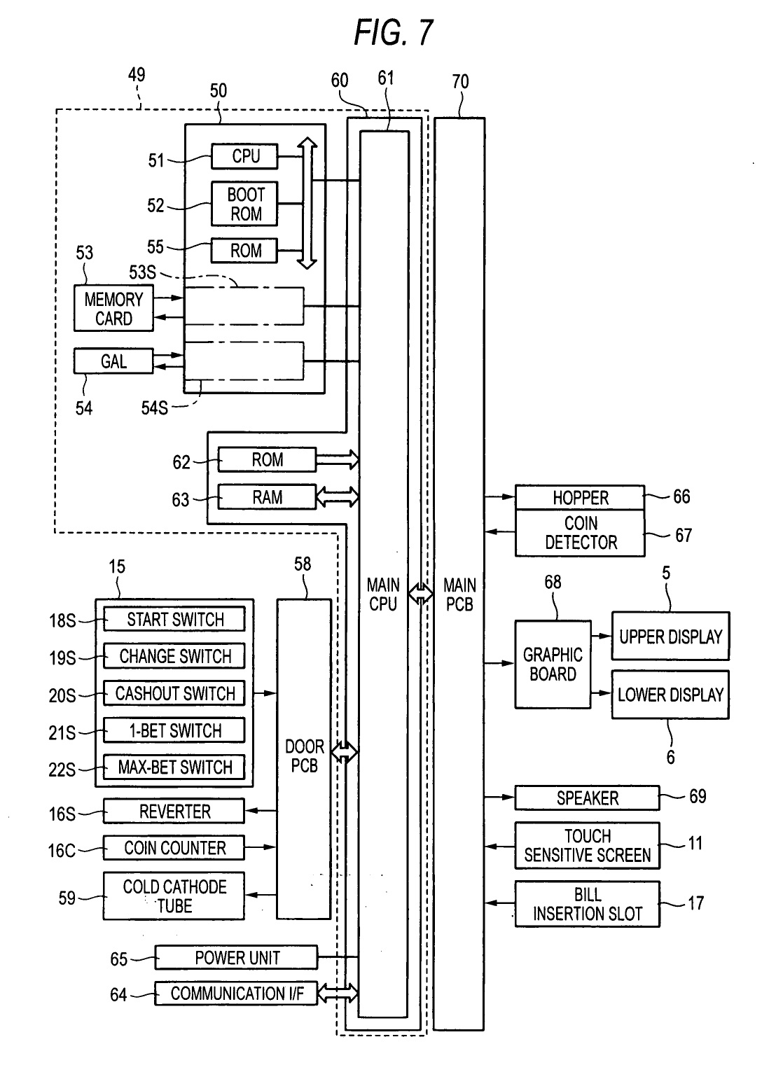

Next, a description will be given of a configuration relating to a control system of the slot machine 1 according to the first embodiment with reference to FIG. 7. FIG. 7 is a block diagram schematically showing a control system of the slot machine 1 according to the first embodiment.

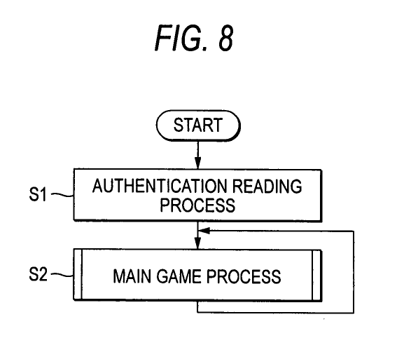

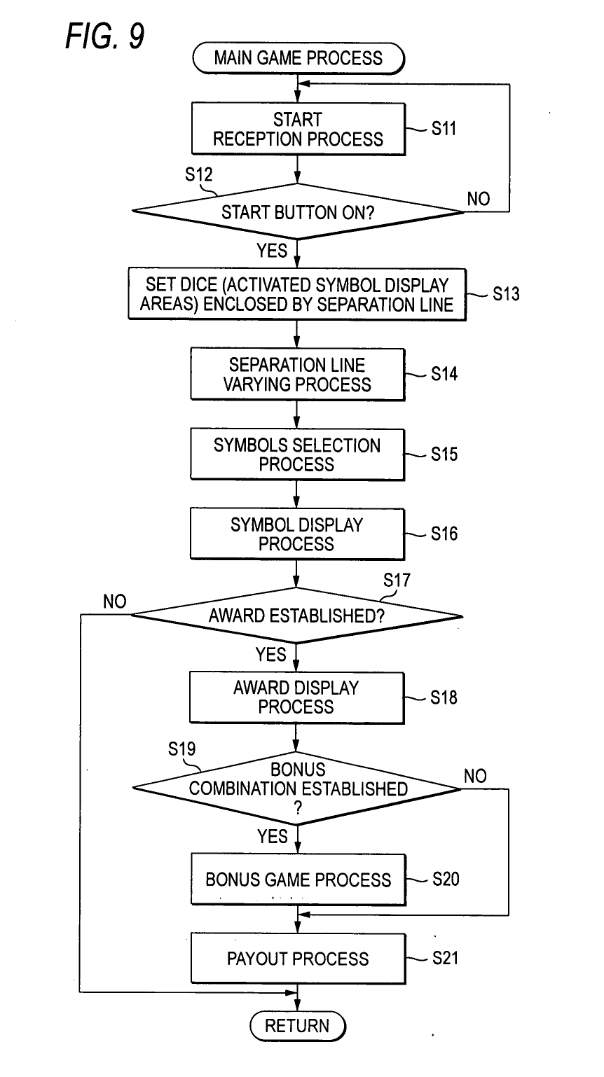

As shown in FIG. 7, the control system of the slot machine 1 is basically configured of a mother board 60 and a game board 50. The game board 50 serves as a controller 49 that executes a plurality of software including a control program shown in FIGS. 8 and 9.

The game board 50 is provided with a CPU 51, an ROM 55 and a boot ROM 52, which are mutually connected via an internal bus, a card slot 53S compatible with a memory card 53, and an IC socket 54S compatible with a GAL (Generic Array Logic) 54.

The memory card 53 is configured of a nonvolatile memory and is a recording medium on which are recorded a game program and a game system program (referred to hereafter as a game related program). A selection program is included in the game program recorded on the memory card 53. The selection program is a program for determining symbols 71A-96A to be stop displayed on the tops of the dice 71-96, which are the symbol display areas.

A symbol selection table for selecting symbols 71A-96A to be stop displayed on the tops of the dice 71-96 is included in the memory card 53. Herein, the symbol selection table is a table in which a predetermined range of random numbers is correlated with six kinds of symbol (“1” to “6”) which can be stop displayed on dice. Then, symbols 71A-96A to be stop displayed on the tops of the dice 71-96 are respectively selected based on the symbol selection table and, subsequently, an award to be awarded to the player is determined based on a combination of, particularly, activated symbols, from among the determined symbols 71A-96A, which dice entirely arranged inside the separation line 97 display.

The symbol selection table may also be a table in which the predetermined range of random numbers is correlated with prizes to be awarded to the player. In this case, first, based on the symbol selection table, an award to be awarded to the player is selected and, subsequently, a combination of symbols 71A-96A corresponding to the determined award is selected by a main CPU 61.

A description will be given of the mother board 60. The mother board 60 is configured using a commercially available general-purpose mother board (a printed circuit board mounted with basic parts of a personal computer), and includes the main CPU 61, an ROM 62, an RAM 63 and a communication interface 64.

Permanent data, such as a program such as a BIOS, included in a memory device such as a flash memory and executed by the main CPU 61, are stored in the ROM 62. When the BIOS is executed by the main CPU 61, a process of initializing a predetermined peripheral device is performed, and a process of downloading the game related program stored on the memory card 53 is started via the game board 50.

Data and a program used when the main CPU 41 operates are stored in the RAM 63. The RAM 63 can store various programs, such as an authentication program and the game related program, which are read via the game board 50, and various information, such as the credit count which the player currently owns.

The communication interface 64 is a communication device for performing a communication with a server or the like, installed in the game arcade, via a communication line.

A main PCB 70 and a door PCB 58, to be described hereafter, are each connected to the mother board 60 via a USB. A power unit 65 is connected to the mother board 60. When power is supplied to the mother board 60 from the power unit 65, the main CPU 61 of the mother board 60 is booted up. Furthermore, the power is supplied to the game board 50 via a PCI bus, and the CPU 51 is booted up.

A hopper 66, a coin detector 67, a graphic board 68, a speaker 69, the touch sensitive screen 11, the bill insertion slot 17 and the like are connected to the main PCB 70.

The graphic board 68, based on a control signal from the main CPU 61, controls image displays on the upper display 5 and the lower display 6. For example, the graphic board 68 displays the payout table and a help screen on the upper display 5, and performs a varying display and a stop display on the lower display 6 of the symbols 71A-96A in conjunction with the rolling of the dice 71-96.

The door PCB 50 is connected with the control panel 15, a reverter 16S, a coin counter 16C and a cold cathode tube 59. A START switch 18S for the START button 18, a CHANGE switch 19S for the CHANGE button 19, a CASH OUT switch 20S for the CASH OUT button 20, a 1-BET switch 21S for the 1-BET button 21, and a MAX-BET switch 22S for the MAX-BET button 22 are provided on the control panel 15. Each switch, when the corresponding button is operated by the player, transmits an input signal to the main CPU 61.

A detailed description will be given, while referring to the drawings, of a main control program executed by the slot machine 1 according to the first embodiment. FIG. 8 is a flowchart of the main control program.

It is assumed that the slot machine 1 already has the memory card 53 inserted in the card slot 53S of the game board 50, and the GAL 54 attached to the IC socket 54S.

First, when the power is turned on in the power unit 65, the mother board 60 and the game board 50 are each booted up, and an authentication reading process of step (abbreviated hereafter to S) 1 is executed. In the authentication reading process, the mother board 60 and the game board 50 each carry out a distinct process in parallel.

That is, in the game board 50, the CPU 51 performs a reading of a preliminary authentication program stored in the boot ROM 52 and, in accordance with the preliminary authentication program read, performs a preliminary authentication which confirms and certifies in advance that no alteration of the authentication program is carried out, before it is downloaded onto the mother board 60.

Meanwhile, in the mother board 60, the main CPU 61 executes the BIOS stored in the ROM 62 and, expanding compressed data embedded in the BIOS to the RAM 63, performs an execution of the BIOS enlarged to the RAM 63, and a diagnosis and initialization of each kind of peripheral device.

Subsequently, the main CPU 61 reads the authentication program stored in the ROM 55, and performs an authentication which confirms and certifies that the game related program stored in the memory card 53 inserted in the card slot 53S has not been altered. When this authentication process finishes normally, the main CPU 61 writes the game related program subjected to the authentication (authenticated) onto the RAM 63. Continuing on, the main CPU 61 performs a downloading process of reading payout ratio setting data stored in the GAL 54 via the game board 50, and writes the read payout ratio setting data onto the RAM 63.

After performing the heretofore described processes, the main CPU 61 finishes the authentication reading process.

Then, in S2, the main CPU 61 performs a main game process by sequentially reading the game related program authenticated in the heretofore described authentication reading process of S1 from the RAM 63, and executing them. By executing this main game process, the game on the slot machine 1 according to the first embodiment is performed. Then, the main game process is repeatedly executed for as long as the power is being supplied to the slot machine 1.

Next, a description will be given, based on FIG. 9, of a sub-process of the heretofore described main game process of S2. FIG. 9 is a flowchart of a main game process program in the slot machine 1 according to the first embodiment. Each of the following programs shown in the flowchart of FIG. 9, being stored in the memory card 53, is enlarged to the RAM 63 furnished on the slot machine 1, and executed by the main CPU 61.

First, as shown in FIG. 9, in S11, the main CPU 61, after performing a predetermined initial setting, performs a start reception process of allowing a coin insertion and setting a bet count or the like. At this time, in the initialization process, a process of clearing data of items set in a predetermined data area (for example, a payout count counter or the like) and so on is performed. Also, in the start reception process, the player performs the coin insertion and a betting operation of using the 1-BET button 21 or the MAX-BET button 22 to set a bet count in a current game at one of 1 to 5.

Next, in S12, the main CPU 61 performs a determination as to whether or not the START button 18 is pressed. The determination as to whether or not the START button 18 is pressed is performed based on whether or not the input signal from the START switch 18S is received.

Then, if the START button 18 has not been pressed (S12: NO), the main CPU 61 returns again to the start reception process (S11). At this time, an operation, such as a revision or the like of the bet count, is possible. Contrarily, if the START button 18 is pressed (S12: YES), the main CPU 61, as well as subtracting the bet count set based on the operation of the 1-BET button 21 or the MAX-BET button 22 from the owned credit count, stores a result in the RAM 63 as bet information.

Subsequently, in S13, the main CPU 61, based on the bet count received in the heretofore described start reception process of S11, sets dice 71-96 (that is, activated symbol display areas) to be enclosed by the separation line 97. For example, when the bet count is 1, as shown in FIG. 1, five pieces of dice 71-75 are set as the activated symbol display areas. When the bet count is 5, as shown in FIG. 2, 11 pieces of dice 71-81 are set as the activated symbol display areas.

In S14, the main CPU 61, based on the activated symbol display areas set in S13, performs a display control of reducing or increasing a present size of an area enclosed by the separation line 97 displayed on the symbol display screen 7. By this means, only dice, which have been newly set as activated symbol display areas based on a currently received bet count, are enclosed by the separation line 97. A color of the dice enclosed by the separation line 97 is changed in such a way as to take on a color differing from that of the other dice (for example, from white to yellow).

Next, in S15, the main CPU 61 executes a symbol selection process of selecting symbols 71A-96A to be displayed on the tops of the dice 71-96 arranged in the symbol display screen 7. Specifically, the main CPU 61, by executing a random number generation program included in the selection program stored in the RAM 63, samples random numbers from within a numeric range in the predetermined range of random numbers and, based on the sampled random numbers and the symbol selection table, determines 26 symbols 71A-96A, from among six kinds of symbol “1” to “6”, to be displayed one on the top of each of the dice 71-96.

In S16, the main CPU 61 starts a rolling of the dice 71-96 displayed on the symbol display screen 7, and variably displays the “1” to “6” symbols arranged on the faces of each of the dice 71-96 at a predetermined rate (refer to FIG. 4). Subsequently, when the predetermined time lapses, the rolling of the dice 71-96 is stopped, and the symbols 71A-96A are displayed one on the top of each of the dice 71-96 (refer to FIG. 5).

In S17, the main CPU 61 determines whether or not a combination of activated symbols displayed on the dice set as the activated symbol display areas in S13, that is, a combination of symbols displayed on dice positioned inside the area enclosed by the separation line 97, is a specific combination for which any award is provided.

Then, the main CPU 61, if determined that the combination is the award providing combination (S17: YES), moves to S18. The main CPU 61, if determined that it is not the award providing combination (S17: NO), finishes the main game process. If the game continues to be started from next time onwards, the processes from S1 onwards are carried out again.

In S18, the main CPU 61, by displaying an award based on the established combination on the lower display 6, notifies the player of details of the award. For example, in FIG. 2, three “2” symbols, two “4” symbols, two “5” symbols and four “6” symbols are displayed as the symbols 71A-81A and, as a result, a combination is established for which is provided an award of 100 credits based on the fact that four “6” symbols are displayed at the same time. Consequently, letters “Win 100”, notifying that a total of 100 credits is provided as an award, are displayed.

In S19, the main CPU 61 determines, by means of the heretofore described symbol display process of S16, whether or not a combination of activated symbols arranged inside the separation line 97 has established a bonus combination. Herein, the bonus combination is a combination configured of the “1” symbols alone.

As a result, the main CPU 61, if determined that the bonus combination is established (S19: YES), moves to a bonus game process (S20). Although it is possible to consider various modes as the bonus game, herein, a description will be given with a free game taken as the bonus game. Herein, the free game being a game in which a game equal to the base game is performed a predetermined number of times, a rolling and stopping control of the dice 71-96 is repeatedly carried out a predetermined number of times in the heretofore mentioned bonus game process of S20, an award established during which is provided to the player in a payout process of S21, to be described hereafter. As conditions of making a transition to the bonus game, it is possible to set various conditions under which it is acceptable to either make the transition in the event that a predetermined number or more of predetermined symbols are displayed, or arrange that the transition occurs suddenly for some unknown reason. As a selection table used during the free game, it is also acceptable to employ a selection table set in such a way as to pay out more than in the base game.

Then, in S21, the main CPU 61 pays out an award based on a combination of the displayed symbols to the player. At this time, by pressing the CASH OUT button 20, it is also possible to provide the award as coins corresponding to the credit count (one credit corresponds to one coin), and it is also possible to provide the award as a ticket with a bar code printed thereon.

As described heretofore, in the slot machine 1 according to the first embodiment, at the game start time, by the player's operation using the 1-BET button 21 or the MAX-BET button 22, the bet count in the current game is received as one of 1 to 5 (S11), and Activated symbol display areas displaying activated symbols which are to constitute the award providing combination are set based on the received bet count (S13). Subsequently, the separation line 97 is displayed reduced or increased in such a way as to enclose dice which are the set activated symbol display areas (S14), after which, the dice 71-96 each start rolling and, after the predetermined time lapses, a total of 26 symbols 71A-96A are stop displayed on the tops of the dice 71-96 (S16). As a result, as an award is provided to the player based on a combination of symbols displayed on the dice which are the set activated symbol display areas (S21), it is possible, by variously changing a combination pattern of symbols to be activated, to provide the player with an attractive game. Also, by changing a possibility of establishment of the award providing combination, expectations for the game are raised.

Also, by the received bet count increasing, as the controller increases the number of activated symbol display areas, the possibility of establishment of the award providing combination is heightened, enabling the player to carry out the game with a larger bet count.

Furthermore, by displaying the separation line 97 which separates the set activated symbol display areas from the other symbol display areas, or differentiating the display state of the activated symbol display areas from that of the other symbol display areas (S14), it is possible to easily ascertain symbol display areas set as the activated symbol display areas.

### SECOND EMBODIMENT

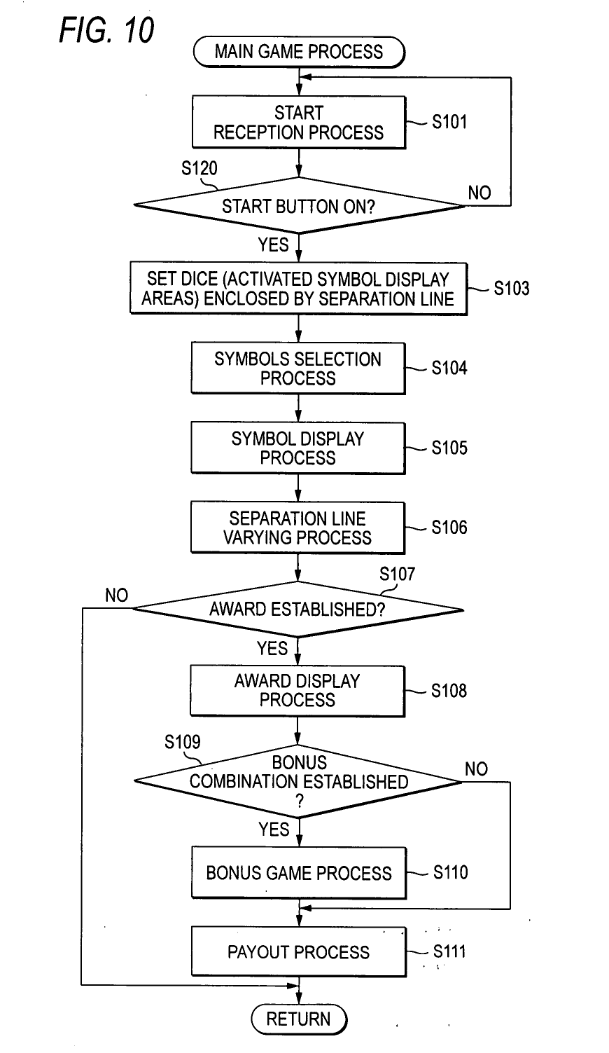

Next, a slot machine according to a second embodiment will be described with reference to FIG. 10. In the following description, the same reference numerals as those of the components of the slot machine 1 according to the heretofore described first embodiment designate parts identical or equivalent to the components of the slot machine 1 or the like according to the heretofore described first embodiment.

A configuration of the slot machine according to the second embodiment is substantially the same as that of the slot machine 1 according to the first embodiment. Also, each kind of control process is also substantially the same as that of the slot machine 1 according to the first embodiment.

However, the slot machine 1 according to the first embodiment, after firstly performing the display control of expanding or reducing the separation line 97 based on the received bet count, displays the symbols 71A-96A on the dice 71-96, while the slot machine according to the second embodiment differs from the slot machine 1 according to the first embodiment in that, after firstly displaying the symbols 71A-96A on the dice 71-96, it performs the display control of expanding or reducing the separation line 97 based on the received bet count.

Hereafter, a description will be given, based on FIG. 10, of a sub-process of the main game process which the slot machine according to the second embodiment executes in the heretofore described S2. FIG. 10 is a flowchart of a main game process program in the slot machine according to the second embodiment.

First, as shown in FIG. 10, in S101, the main CPU 61, after performing a predetermined initialization, performs a start reception process of allowing a coin insertion and setting a bet count or the like. At this time, in the initialization process, a process of clearing data of items set in a predetermined data area (for example, the payout count counter or the like) and so on is performed. Also, in the start reception process, the player performs the coin insertion and a betting operation of using the 1-BET button 21 or the MAX-BET button 22 to set a bet count in a current game at one of 1 to 5.

Next, in S102, the main CPU 61 performs a determination as to whether or not the START button 18 is pressed. The determination as to whether or not the START button 18 is pressed is performed based on whether or not the input signal from the START switch 18S is received.

Then, if the START button 18 has not been pressed (S102: NO), the main CPU 61 returns again to the start reception process (S101). At this time, an operation, such as the revision or the like of the bet count, is possible. Meanwhile, if the START button 18 is pressed (S102: YES), the main CPU 61, as well as subtracting the bet count set based on the operation of the 1-BET button 21 or the MAX-BET button 22 from the owned credit count, stores a result in the RAM 63 as the bet information.

Subsequently, in S103, the main CPU 61, based on the bet count received in the heretofore described start reception process of S101, sets dice 71-96 (that is, activated symbol display areas) to be enclosed by the separation line 97. For example, when the bet count is 1, as shown in FIG. 1, five pieces of dice 71-75 are set as the activated symbol display areas. Also, when the bet count is 5, as shown in FIG. 2, 11 pieces of dice 71-81 are set as the activated symbol display areas.

Next, in S104, the main CPU 61 executes a symbol selection process of selecting symbols 71A-96A to be displayed on the tops of the dice 71-96 arranged in the symbol display screen 7. Specifically, the main CPU 61, by executing a random number generation program included in the selection program stored in the RAM 63, samples random numbers from within the numeric range in the predetermined range of random numbers and, based on the sampled random numbers and the symbol selection table, determines 26 symbols 71A-96A, from among six kinds of symbol “1” to “6”, to be displayed on the tops of the dice 71-96 respectively.

In S105, the main CPU 61 starts a rolling of the dice 71-96 displayed on the symbol display screen 7, and variably displays the “1” to “6” symbols arranged on the faces of each of the dice 71-96 at the predetermined rate (refer to FIG. 4). Subsequently, when the predetermined time lapses, the rolling of the dice 71-96 is stopped, and the symbols 71A-96A are displayed one on the top of each of the dice 71-96 (refer to FIG. 5).

In S106, the main CPU 61, based on the activated symbol display areas set in S103, performs a display control of reducing or increasing a present size of an area enclosed by the separation line 97 displayed on the symbol display screen 7. By this means, only dice, which have been newly set as activated symbol display areas based on a currently received bet count, are enclosed by the separation line 97. A color of the dice enclosed by the separation line 97 is changed in such a way as to take on a color differing from that of the other dice (for example, from white to yellow).

As subsequent processes of S107 to S111 are the same as the already described processes of S7 to S11 in the main process program (FIG. 9) according to the first embodiment, a description thereof will be omitted here.

As described heretofore, in the slot machine according to the second embodiment, at the game start time, by the player's operation using the 1-BET button 21 or the MAX-BET button 22, the bet count in the current game is received as one of 1 to 5 (S101), and Activated symbol display areas displaying activated symbols which are to constitute the award providing combination are set based on the received bet count (S103). Subsequently, the dice 71-96 all start rolling, a total of 26 symbols 71A-96A are stop displayed on the tops of the dice 71-96 after the predetermined time lapses and, continuing, the separation line 97 is displayed enlarged or reduced in such a way as to enclose dice which are the set activated symbol display areas (S106). As a result, as an award is provided to the player based on a combination of activated symbols enclosed by the separation line 97 (S121), it is possible, by variously changing a combination pattern of symbols to be activated, to provide the player with the attractive game. Also, by changing the possibility of establishment of the award providing combination, expectations for the game are raised.

Also, by the received bet count increasing, as the controller increases the number of activated symbol display areas, the possibility of establishment of the award providing combination is heightened, enabling the player to carry out the game with a larger bet count.

Furthermore, by displaying the separation line 97 which separates the set activated symbol display areas from the other symbol display areas, or differentiating the display state of the activated symbol display areas from that of the other symbol display areas (S106), it is possible to easily ascertain symbol display areas set as the activated symbol display areas.

### THIRD EMBODIMENT

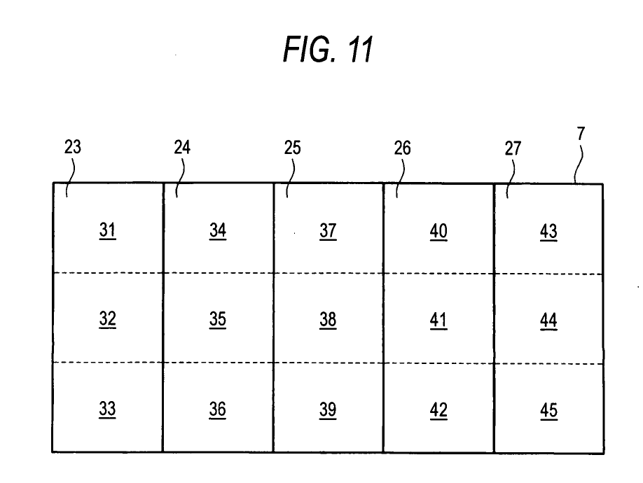

A slot machine according to a third embodiment will be described with reference to FIGS. 11-14. In the following description, the same reference numerals as those of the components of the slot machine 1 according to the heretofore described first embodiment designate parts identical or equivalent to the components of the slot machine 1 or the like according to the heretofore described first embodiment.

An outline configuration of the slot machine according to the third embodiment is substantially the same as that of the slot machine 1 according to the first embodiment. Also, each kind of control process is also substantially the same as that of the slot machine 1 according to the first embodiment.

However, the slot machine 1 according to the first embodiment employs the dice 71-96 as symbol display areas displaying symbols, while the slot machine according to the third embodiment differs from the slot machine 1 according to the first embodiment in employing reels as the symbol display areas displaying the symbols.

Hereafter, a description will be given, based on FIGS. 11-14, of symbols which are displayed on the symbol display screen 7 of the lower display 6 during the game. FIG. 11 is a front view showing the symbol display screen 7 of the slot machine according to the third embodiment.

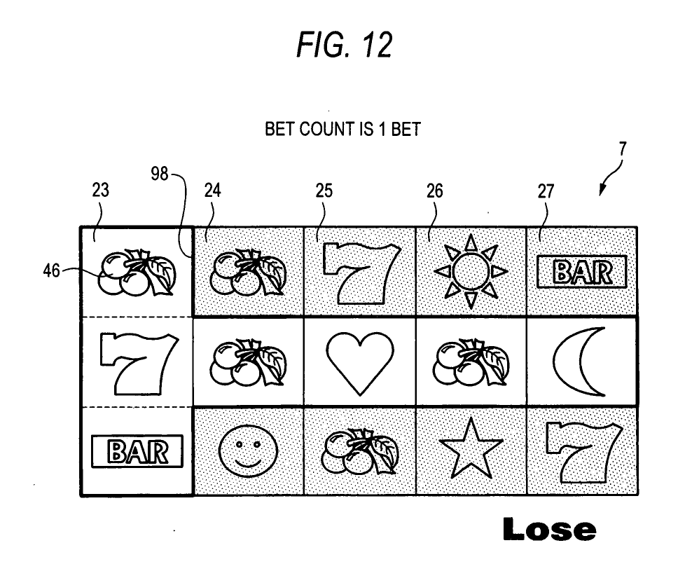

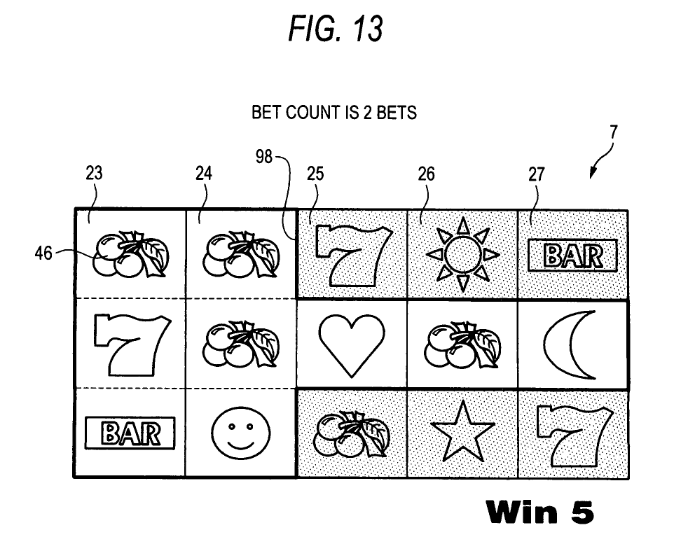

As shown in FIG. 11, the symbol display screen 7 displayed on the lower display 6 of the slot machine according to the third embodiment is configured of five reels 23-27. The reels 23-27 have symbol display areas 31-45 for displaying three symbols 46 on each of the reels 23-27 when a rotation of the reels 23-27 is stopped. When the game is started, as shown in FIGS. 12 and 13, symbols 46 (a total of 15 symbols) are displayed one in each symbol display area 31-45. Although the symbol display areas 31-45 are divided by dotted lines in the figure in order to distinguish one area from another, it is also acceptable to configure in such a way as not to display these dotted lines.

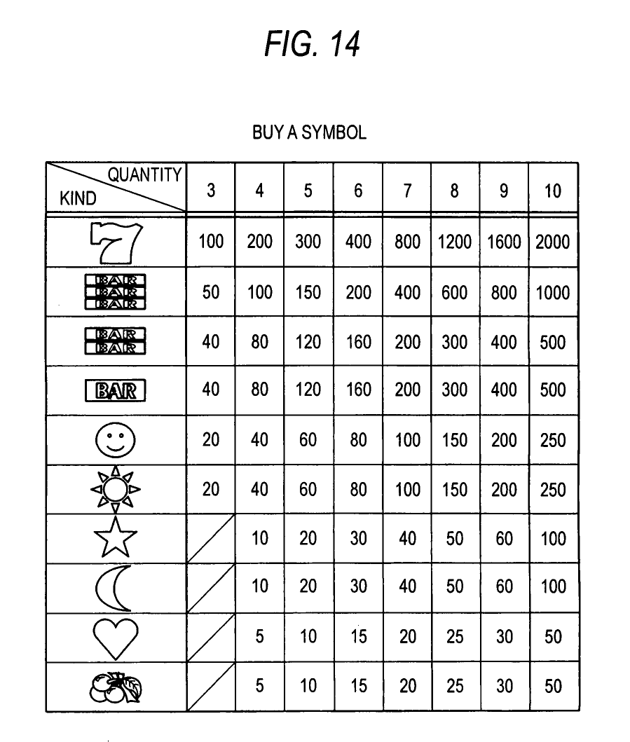

Herein, in the slot machine according to the third embodiment, the game is performed using 10 kinds of symbol 46 shown in FIG. 14 and a blank (a blank symbol). A win occurs in the event that a combination is established in which a predetermined number or more of symbols of the same kind are displayed in the symbol display areas 31-45 regardless of a disposition, and an award corresponding to a kind and a display quantity of the symbols is provided. Also, in the event that a bonus combination is established in which “7” symbols 46 align horizontally in symbol display areas 31-45, as the award, the bonus game is executed continuously after a finish of the base game.

Then, in the slot machine according to the third embodiment, symbols in symbol display areas (activated symbol display areas), from among 15 symbol display areas 31-45, arranged inside a separation line 98, a size of an area enclosed by which is changed based on the number of bets made by the player at the start reception time, become candidates for a combination which establishes an award. As the activated symbol display areas (in FIG. 12, the symbol display areas 31 to 33, 35, 38, 41 and 44) which can be elements of the combination are displayed in a color differing from that of the other symbol display areas (in FIG. 12, the symbol display areas 34, 36, 37, 39, 40, 42, 43 and 45) (for example, gray and white), it is possible for the player to easily ascertain activated symbol display areas displaying activated symbols which can be elements of a combination. As a method of distinguishing the activated symbol display areas, apart from differentiating display colors, it is sufficient to display the activated symbol display areas with their display state differentiated from that of the other symbol display areas. For example, it is possible to light only the activated symbol display areas using a backlight, and so on.

Herein, FIG. 12 is a view showing the symbol display screen 7 in a case in which the player starts the game with 1 BET, and symbols 46 are stop displayed one in each symbol display area 31-45. FIG. 13 is a view showing the symbol display screen 7 in a case in which the player starts the game with 2 BETs, and symbols 46 are stop displayed one in each symbol display area 31-45.

As shown in FIG. 12, when the bet count is 1, only the symbol display areas 31 to 33, 35, 38, 41 and 44 are set as the activated symbol display areas. Then, it is determined, based on a combination of seven symbols 46 displayed in the symbol display areas 31 to 33, 35, 38, 41 and 44, whether or not the award providing combination is established. Consequently, no award is provided in the combination shown in FIG. 12.

As shown in FIG. 13, when the bet count is 2, the symbol display areas 31 to 36, 38, 41 and 44 are set as the activated symbol display areas. Then, it is determined, based on a combination of nine symbols 46 displayed in the symbol display areas 31 to 36, 38, 41 and 44, whether or not the award providing combination is established. Consequently, in the combination shown in FIG. 13, a combination is established for which is provided an award of five credits based on a fact that four “CHERRY” symbols are displayed.

Although no illustration is given for when the bet count is 3, 4 or 5, when the bet count is 3, the symbol display areas 31 to 39, 41 and 44 are set as the activated symbol display areas, and the activated symbol display areas increase in comparison with when it is 2. In the same way, when the bet count is 4, the symbol display areas 31 to 43 and 44 are set as the activated symbol display areas, and the activated symbol display areas increase in comparison with when it is 3. Furthermore, when the bet count is 5, the symbol display areas 31-45 are set as the activated symbol display areas, and the activated symbol display areas is largest in number.

In the third embodiment, a win occurs in the event that a predetermined number of symbols of the same kind shown in FIG. 14 is displayed, and an award is provided, but it is also acceptable to configure in such a way that a win occurs in the event that one “7” symbol and three “CHERRY” symbols are displayed, and an award is provided.

Also, regarding an award, it is also acceptable that a pay line is set on the symbol display areas 31-45, and the award is provided in the event that a combination of symbols stopped on the pay line is a predetermined combination.

A specific description will be given of a game implementation procedure of the slot machine according to the third embodiment. First, when the START button 18 is pressed after a finish of the bet reception, symbol display areas displaying symbols which establish an award providing combination (that is, activated symbol display areas) are determined based on the number of bets made by the player. Subsequently, an internal selection process of determining symbols 46 to be displayed one in each symbol display area 31-45 is performed, at the point at which the predetermined time has elapsed after the START button 18 is pressed, the reels 23-27 start rotating, a scroll display of symbol columns is performed and, after the predetermined time lapses, a total of 15 symbols 46 are stop displayed in the symbol display areas 31-45. Then, in consideration of the activated symbol display areas determined based on the bet count, details of an award are determined based on a combination of symbols stop displayed only in the activated symbol display areas, and the award is provided.

As described heretofore, in the slot machine according to the third embodiment, at the game start time, by the player's operation using the 1-BET button 21 or the MAX-BET button 22, a bet count in a current game is received as one of 1 BET to 5 BETs, and Activated symbol display areas displaying activated symbols which are to constitute the award providing combination are set based on the received bet count. Subsequently, the separation line 98 is displayed in such a way as to enclose the set activated symbol display areas, after which, the reels 23-27 all start rotating and, after the predetermined time lapses, a total of 15 symbols 46 are stop displayed in the symbol display areas 31-45. As a result, as an award is provided to the player based on a combination of symbols stop displayed in activated symbols positioned inside an area enclosed by the separation line 98, it is possible, by variously changing a combination pattern of symbols to be activated, to provide the player with the attractive game. Also, by changing the possibility of establishment of the award providing combination, expectations for the game are raised.

Also, by the received bet count increasing, as the controller increases the number of activated symbol display areas, the possibility of establishment of the award providing combination is heightened, enabling the player to carry out the game with a larger bet count.

Furthermore, by displaying the separation line 98 which separates the set activated symbol display areas from the other symbol display areas, or differentiating the display state of the activated symbol display areas from that of the other symbol display areas, it is possible to easily ascertain symbol display areas set as the activated symbol display areas.

### FOURTH EMBODIMENT

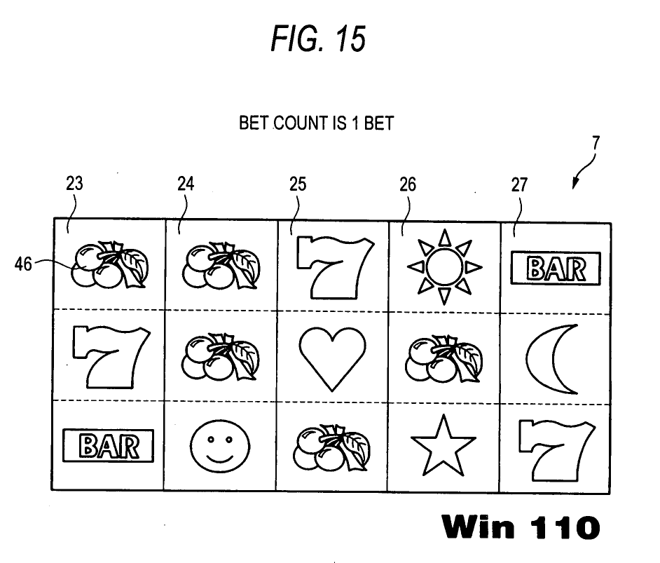

Next, a description will be given, based on FIGS. 15-17, of a slot machine according to a fourth embodiment. In the following description, the same reference numerals as those of the components of the slot machine 1 according to the heretofore described first embodiment in FIGS. 1-9 designate parts identical or equivalent to the components of the slot machine 1 or the like according to the heretofore described first embodiment.

An outline configuration of the slot machine according to the fourth embodiment is substantially the same as that of the slot machine 1 according to the first embodiment. Also, each kind of control process is also substantially the same as that of the slot machine 1 according to the first embodiment.

However, the slot machine 1 according to the first embodiment employs the dice 71-96 as symbol display areas displaying symbols, while the slot machine according to the fourth embodiment differs from the slot machine 1 according to the first embodiment in employing reels as the symbol display areas displaying the symbols and, as the bet count received in the slot machine increases, forming new symbol display areas contiguous with the existing symbol display areas.

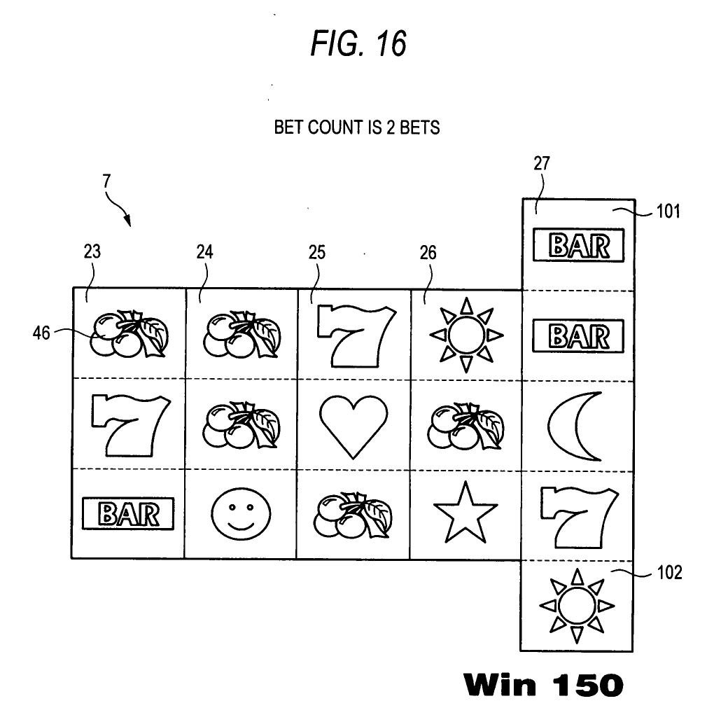

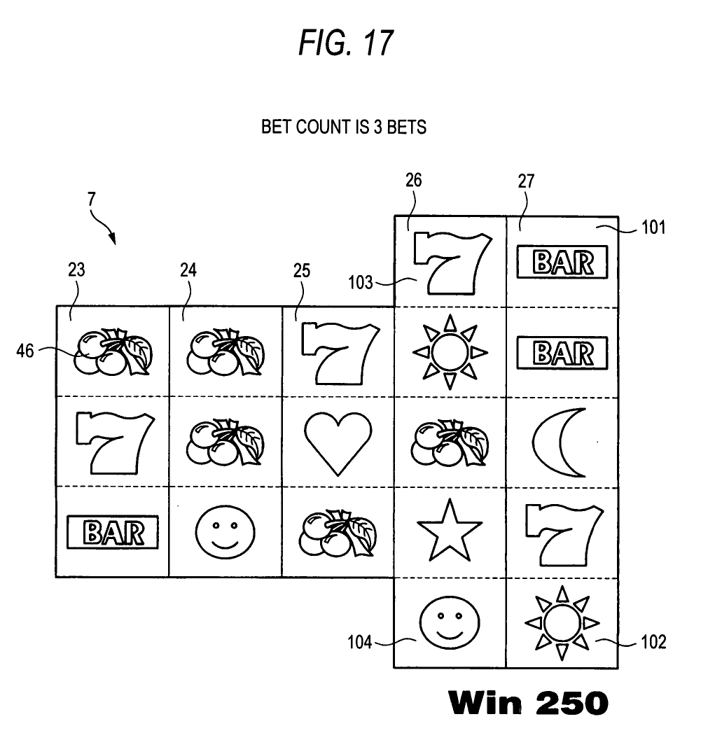

Hereafter, a description will be given, based on FIGS. 15-17, of symbols which are displayed on the symbol display screen 7 of the lower display 6 during the game. FIG. 15 is a view showing the symbol display screen 7 in a case in which the player starts the game with 1 BET, and symbols 46 are stop displayed one in each symbol display area. Also, FIG. 16 is a view showing the symbol display screen 7 in a case in which the player starts the game with 2 BETs, and symbols 46 are stop displayed one in each symbol display area. Furthermore, FIG. 17 is a view showing the symbol display screen 7 in a case in which the player starts the game with 3 BETs, and symbols 46 are stop displayed one in each symbol display area.

Herein, in the slot machine according to the fourth embodiment, symbols displayed in activated symbol display areas, which increase or decrease based on the number of bets made by the player at the start reception time, become candidates for a combination which establishes an award. As the received bet count increases, new activated symbol display areas are formed on the symbol display screen 7.

First, to give a description of a case in which the bet count received in the slot machine according to the fourth embodiment is 1, in the same way as in the third embodiment, the symbol display screen 7 displayed on the lower display 6 is configured of five reels 23-27 (refer to FIG. 11). Then, the reels 23-27 have symbol display areas 31-45 for displaying three symbols 46 on each reels 23-27 when a rotation of the reels 23-27 is stopped. When the game is started, as shown in FIG. 15, symbols 46 (a total of 15 symbols) are displayed one in each symbol display area 31-45. Although the symbol display areas 31-45 are divided by dotted lines in the figure in order to distinguish one area from another, it is also acceptable to configure in such a way as not to display these dotted lines.

Herein, in the slot machine according to the fourth embodiment, in the same way as in the slot machine according to the third embodiment, the game is performed using 10 kinds of symbol 46 shown in FIG. 14 and a blank (a blank symbol). A win occurs in the event that a combination is established in which a predetermined number or more of symbols of the same kind are displayed in the symbol display areas 31-45 regardless of a disposition, and an award corresponding to a kind and a display quantity of the symbols is provided. Also, in the event that a bonus combination is established in which “7” symbols 46 align horizontally in symbol display areas 31-45, as the award, the bonus game is executed continuously after a finish of the base game.

Consequently, in the combination shown in FIG. 15, a combination is established for which is provided an award of 110 credits in which are combined an award of 10 credits based on a fact that five “CHERRY” symbols are displayed, and an award of 100 credits based on a fact that three “7” symbols are displayed.

Next, to give a description of a case in which the bet count received in the slot machine according to the fourth embodiment is 2, in contrast with the case of 1 BET, new symbol display areas 101 and 102 are additionally displayed in the symbol display screen 7 displayed on the lower display 6 in contiguity with a top and a bottom of the reel 27. When the game is started, as shown in FIG. 16, symbols 46 (a total of 17 symbols) are displayed one in each symbol display area 31-45, 101 and 102.

Then, in the combination shown in FIG. 16, a combination is established for which is provided an award of 150 credits in which are combined an award of 10 credits based on a fact that five “CHERRY” symbols are displayed, an award of 100 credits based on a fact that three “7” symbols are displayed, and an award of 40 credits based on a fact that three “1 BAR” symbols are displayed.

Next, to give a description of a case in which the bet count received in the slot machine according to the fourth embodiment is 3, in contrast with the case of 2 BETs, new symbol display areas 103 and 104 are additionally displayed in the symbol display screen 7 displayed on the lower display 6 in contiguity with a top and a bottom of the reel 26. When the game is started, as shown in FIG. 17, symbols 46 (a total of 19 symbols) are displayed one in each symbol display area 31-45 and 101-104.

In the example shown in FIG. 17, a combination is established for which is provided an award of 250 credits in which are combined an award of 10 credits based on a fact that five “CHERRY” symbols are displayed, an award of 200 credits based on a fact that four “7” symbols are displayed, and an award of 40 credits based on a fact that three “1 BAR” symbols are displayed.

Although no illustration is given for when the bet count is 4 or 5, when the bet count is 4, new symbol display areas are additionally displayed in contiguity with a top and a bottom of the reel 25 in contrast with the case of 3 BETs. Furthermore, when the bet count is 5, new symbol display areas are additionally displayed in such a way as to be contiguous to a top and a bottom of the reel 24 in contrast with the case of 4 BETs.

A specific description will be given of a game implementation procedure of the slot machine according to the fourth embodiment. First, when the START button 18 is pressed after a finish of the bet reception, based on the number of bets made by the player, symbol display areas (that is, activated symbol display areas) displaying symbols which establish the award providing combination are determined and, in a case of increasing the number of activated symbol display areas, a display control is performed in such a way as to newly form activated symbol display areas on the symbol display screen 7. Subsequently, an internal selection process of determining symbols 46 to be displayed one in each symbol display area is performed, the reels 23-27 start rotating at the point at which the predetermined time has elapsed after the START button 18 is pressed, the scroll display of the symbol columns is performed and, after the predetermined time lapses, a total of 15 to 23 symbols 46 are stop displayed in 15 to 23 symbol display areas determined in accordance with the bet count. Then, details of an award are determined based on a combination of symbols stop displayed in the activated symbol display areas, and the award is provided.

As described heretofore, in the slot machine according to the fourth embodiment, at the game start time, by the player's operation using the 1-BET button 21 or the MAX-BET button 22, a bet count in the current game is received as one of 1 to 5, and Activated symbol display areas displaying activated symbols which are to constitute the award providing combination are set based on the received bet count. Subsequently, in a case of increasing present activated symbol display areas, new symbol display areas are displayed on the symbol display screen 7. The reels 23-27 all start rotating and, after the predetermined time lapses, a total of 15 to 23 pieces of symbols 46 are stop displayed in 15 to 23 pieces of symbol display areas determined in accordance with the bet count. As a result, as an award is provided to the player based on a combination of symbols stop displayed in the set activated symbol display areas, it is possible, by changing a combination pattern of symbols to be activated, to provide the player with the attractive game. Also, by changing the possibility of establishment of the award providing combination, expectations for the game are raised.

Also, by the received bet count increasing, as the controller increases the number of activated symbol display areas, the possibility of establishment of the award providing combination is heightened, enabling the player to carry out the game with a larger bet count.

The present invention is not limited to the embodiments described above. Various improvements and modifications are possible to the slot machine without departing from the scope of the present invention.

For example, in the first to third embodiments, activated symbol display areas displaying activated symbols which are candidates for an award payout are changed on condition that the received bet count increases, but it is also acceptable to make other than the bet count a condition. For example, it is also possible to increase the activated symbol display areas in the event that a payout ratio reaches 90% or less, and to reduce the activated symbol display areas in the event that the payout ratio reaches 95% or more. Also, it is also possible to increase the activated symbol display areas for several games in the event that a combination of symbols is a predetermined combination.

Also, in the first and second embodiments, dice entirely enclosed by the separation line 97 are considered to be the activated symbol display areas, but it is also acceptable that a partially enclosed die is also considered to be the activated symbol display area.

Also, in the third embodiment, by the received bet count increasing, the activated symbol display areas increase in accordance with a predetermined rule (refer to FIGS. 12 and 13), but it is also acceptable that active symbol display areas to be increased in number are selected by the player. In this case, in the event that 2 BETs or more have been received after the bet reception process (S11), it is possible to cause the player to select symbol display areas 31-45 using the touch sensitive screen 11.

As the method of separating the activated symbol display areas from the other symbol display areas, it is also acceptable to rotate a bar-like member like a clock hand, such as on a display screen of a radar device, and separate symbol display areas positioned in a range of the rotation as activated symbol display areas.

Furthermore, the present invention may be applied to a slot machine that is provided with mechanical reels. Also, the present invention may also be applied not only to the slot machine but also to, for example, a poker game machine. In this case, it is possible to change a number of cards dealt in accordance with a bet count of the player.

For example, it is possible, in the case in which the game is started with 1 BET, to deal five cards to the player as normal, and make them candidates for cards which establish a combination and, in the case in which the game is started with 5 BETs, to deal six cards, one more than normal, to the player, and make them candidates for cards which establish a combination.

As described with reference to the embodiments, in the gaming machine and method for providing a game according to the present invention, as the symbol display areas to be set as the activated symbol display areas displaying the symbols which establish the award providing combination are changed in the event that the predetermined condition is satisfied, it is possible, by variously changing a combination pattern of symbols to be activated, to provide the player with an attractive game. Also, by changing the possibility of establishment of the award providing combination, expectations for the game are raised.

Also, by the received bet count increasing, as the controller increases the number of activated symbol display areas, the possibility of establishment of the award providing combination is heightened, enabling the player to carry out the game with a larger bet count.

Furthermore, by displaying the separation line which separates the set activated symbol display areas from the other symbol display areas, or changing the display states of the activated symbol display areas and the other symbol display areas, it is possible to easily ascertain the symbol display areas set as the activated symbol display areas.

That is, in the heretofore known gaming machine, as the activated symbol display areas displaying symbols which establish a combination for which any award is provided, being fixed in advance by the gaming machine, never change, the game becomes monotonous, and it has not been possible to challenge the player to bet a larger number of game media, but it is possible in the present invention to solve this kind of problem.

It is described in the embodiments that the award is “provided” to the player in accordance with the combination of the symbols displayed stopped in the second arrangement. However, the award may be any type of award that is advantageous to the player in playing the game.

The award may be provided to the player by providing the player a bonus game such as a free game, which is played without consumption of any game medium (coins, medals, tokens, or credits), or a second game, which is different from the base game and is more advantageous to the player.

The award may also be provided to the player by transitioning the game to be performed based on an award table having higher odds than the award table shown in FIG. 8 used in the base game.

The award may also be provided to the player by actually paying out tangible game medium (coins, medals, or tokens) to the player, or by paying out non-tangible credits as the game medium to the player. The credits may be accumulated in the gaming machine to be actually paid out later as the tangible game medium.

As described with reference to the embodiments, there is provided a gaming machine that provides a game and includes: a display device; an operation unit that allows a player to input commands for playing the game; and a controller that operates to: control the display device to variably display a plurality of symbols in each of a plurality of symbol display areas when a start command is input through the operation unit; define a part of the symbol display areas as activated symbol display areas; provide an award when a combination of the symbols displayed stopped in the activated symbol display areas satisfies a predetermined combination; and modify the symbol display areas to be defined as the activated symbol display areas when a predetermined condition is satisfied.

There is also provided a gaming machine that provides a game and includes: a display device; an operation unit that allows a player to input commands for playing the game; and a controller that operates to: accept a bet input by the player through the operation unit; control the display device to variably display a plurality of symbols in each of a plurality of symbol display areas when a start command is input through the operation unit; provide an award when a combination of the symbols displayed stopped in the symbol display areas satisfies a predetermined combination; and control the display device to increase a number of symbol display areas to be displayed as a number of bet made by the player through the operation unit increases.

There is also provided a method for providing a game to a player, the method including: allowing a player to input commands for playing the game; variably displaying a plurality of symbols in each of a plurality of symbol display areas when a start command is input by the player; defining a part of the symbol display areas as activated symbol display areas; providing an award when a combination of the symbols displayed stopped in the activated symbol display areas satisfies a predetermined combination; and modifying the symbol display areas to be defined as the activated symbol display areas when a predetermined condition is satisfied.

There is also provided a method for providing a game to a player, the method including: allowing a player to input commands for playing the game; and accepting a bet input by the player; variably displaying a plurality of symbols in each of a plurality of symbol display areas when a start command is input by the player; providing an award when a combination of the symbols displayed stopped in the symbol display areas satisfies a predetermined combination; and increasing a number of symbol display areas to be displayed as a number of bet made by the player increases.

What is claimed is:

1. A gaming machine that provides a game, the gaming machine comprising:
a display device;
an operation unit that allows a player to input commands for playing the game; and
a controller that operates to:
control the display device to variably display a plurality of symbols in each of a plurality of symbol display areas when a start command is input through the operation unit;
define a part of the symbol display areas as activated symbol display areas;
provide an award when a combination of the symbols displayed stopped in the activated symbol display areas satisfies a predetermined combination; and
modify the symbol display areas to be defined as the activated symbol display areas when a predetermined condition is satisfied.

2. The gaming machine according to claim 1, wherein the controller further operates to:
accept a bet input by the player through the operation unit; and
determine a detail of the award in accordance with the bet.

3. The gaming machine according to claim 2, wherein the controller modifies the symbol display areas to be defined as the activated symbol display areas when a number of bet made by the player through the operation unit reaches a predetermined bet count.

4. The gaming machine according to claim 3, wherein the controller modifies to increase the symbol display areas to be defined as the activated symbol display areas as the number of bet made by the player increases.

5. The gaming machine according to claim 1, wherein the controller controls the display device to display a separation line that separates the activated symbol display areas from other symbol display areas.

6. The gaming machine according to claim 5, wherein the controller controls the display device to display the separation line to surround the activated symbol display areas.

7. The gaming machine according to claim 1, wherein the controller controls the display device to display the activated symbol display areas in a display state different from that of other symbol display areas.

8. The gaming machine according to claim 1, wherein the display device includes a display panel that displays various images on a screen, the images including a plurality of video reels on which the symbols are arranged.

9. The gaming machine according to claim 1, wherein the display device includes a plurality of mechanical reels on which the symbols are arranged.

10. A gaming machine that provides a game, the gaming machine comprising:
a display device;
an operation unit that allows a player to input commands for playing the game; and
a controller that operates to:
accept a bet input by the player through the operation unit;
control the display device to variably display a plurality of symbols in each of a plurality of symbol display areas when a start command is input through the operation unit;
provide an award when a combination of the symbols displayed stopped in the symbol display areas satisfies a predetermined combination; and
control the display device to increase a number of symbol display areas to be displayed as a number of bet made by the player through the operation unit increases.

11. The gaming machine according to claim 10, wherein the controller controls the display device to display the additional symbol display areas to be displayed adjacent to other symbol display areas.

12. The gaming machine according to claim 10, wherein the display device includes a display panel that displays various images on a screen, the images including a plurality of video reels on which the symbols are arranged.

13. The gaming machine according to claim 10, wherein the display device includes a plurality of mechanical reels on which the symbols are arranged.

14. A method for providing a game to a player, the method comprising:
allowing a player to input commands for playing the game;
variably displaying a plurality of symbols in each of a plurality of symbol display areas when a start command is input by the player;
defining a part of the symbol display areas as activated symbol display areas;
providing an award when a combination of the symbols displayed stopped in the activated symbol display areas satisfies a predetermined combination; and
modifying the symbol display areas to be defined as the activated symbol display areas when a predetermined condition is satisfied.

15. The method according to claim 14, further comprising:
accepting a bet input by the player; and
determining a detail of the award in accordance with the bet.

16. The method according to claim 15, wherein the symbol display areas to be defined as the activated symbol display areas are modified when a number of bet made by the player reaches a predetermined bet count.

17. The method according to claim 16, wherein the symbol display areas to be defined as the activated symbol display areas are modified to be increased in number as the number of bet made by the player increases.

18. The method according to claim 14, further comprising displaying a separation line that separates the activated symbol display areas from other symbol display areas.

19. The method according to claim 18, wherein the separation line is displayed to surround the activated symbol display areas.

20. The method according to claim 14, wherein the activated symbol display areas are displayed in a display state different from that of other symbol display areas.

21. A method for providing a game to a player, the method comprising:
allowing a player to input commands for playing the game; and
accepting a bet input by the player;
variably displaying a plurality of symbols in each of a plurality of symbol display areas when a start command is input by the player;
providing an award when a combination of the symbols displayed stopped in the symbol display areas satisfies a predetermined combination; and
increasing a number of symbol display areas to be displayed as a number of bet made by the player increases.

22. The method according to claim 21, wherein the additional symbol display areas to be displayed are displayed adjacent to other symbol display areas.
